(19) United States
(12) Patent Application Publication
(10) Pub. No.: US 2004/0065200 A1
(43) Pub. Date: Apr. 8, 2004

(54) Method and apparatus for the removal of particulate from a fluid stream

(76) Inventors: Kok-Keung n.a. Lo, Yuen Long (HK); Ronald M.C. So, Pokuflam (HK); James H. Whitelaw, Kingston (GB)

Correspondence Address: JACOBSON HOLMAN PLLC, 400 SEVENTH STREET N.W., SUITE 600, WASHINGTON, DC, 20004, US

(21) Appl. No.: 10/264,269

(22) Filed: Oct. 4, 2002

(51) Int. Cl. B01D 45/12

(52) U.S. Cl. 95/269; 55/337

(57) ABSTRACT

This invention provides a method and apparatus for the removal of particulate matter from a fluid stream such as particulate matter from the exhaust of diesel engines. The device provides an enlarged diameter primary chamber and deflector plates adjacent an inlet end to swirl the fluid stream around the interior of the outer walls of the primary chamber. An exhaust outlet is directed to draw fluid substantially centrally from the swirling gas flow in the primary chamber such that heavier particulate matter is centrifuged away from the exhaust outlet and may be collected through a particulate matter collection means.

### FIELD OF THE INVENTION

This invention relates to a method and apparatus for the removal of particulate from a fluid stream and, in particular, although not necessarily solely, the removal of particulate matter from the exhaust of diesel engines.

### BACKGROUND TO THE INVENTION

The current political and social environment in many countries is placing greater emphasis on improving the quality of exhaust gases that may lead to pollution of the environment. In a large number of countries, diesel engines used in vehicles or in stationary devices produce a large number of pollutants including a high particulate ratio in the exhaust.

A variety of devices have been suggested in the past to try and improve the quality of such exhaust. However, such devices are often uneconomic or create problems for the diesel engine itself.

Some solutions seek to produce high efficiencies in the removal of particulates and smoke. Such devices may use filtration units in the exhaust and can produce very high figures for particulate removal if desired. However, any filter that is in the direct exhaust stream has the difficulty of producing a considerable back pressure on the engine itself and can seriously degrade the performance of the engine. Furthermore, there is normally high maintenance associated with cleaning the devices or the engine may stale if there is a blockage caused by the filter itself.

### OBJECT OF THE INVENTION

It is an object of the present invention to provide a method and apparatus for the removal of particulate from a fluid stream such as the exhaust gas of a diesel engine which overcome some of the difficulties of the prior art while minimizing the back pressure applied on the engine and reducing the likelihood of the device becoming blocked to block the exhaust from the engine itself.

### SUMMARY OF THE INVENTION

Accordingly, in a first aspect, the invention may broadly be said to consist in a method of removing particulate materials and smoke from exhaust gases comprising:

passing the exhaust gas through means to create a spiral flow to the gas stream around a chamber;

collecting particulate matter at an end of said chamber distal from said means to create spiral flow of said gas; and

drawing exhaust gas from a substantially central portion of the spiral flow about said chamber at a distal end of said chamber from said means to create said spiral flow.

Preferably said method further includes reducing the velocity of the gas flow to create lower velocity flow through said chamber relative to the inlet velocity of the gas flow.

Preferably the method further includes collecting the particulate matter in a secondary chamber communicating with the chamber containing the spiral gas flow.

Preferably said method includes drawing said particulate matter into said secondary chamber with a secondary gas flow or vacuum.

Accordingly, in a second aspect, the invention may broadly be said to consist in a device for the removal of particulate matter from an exhaust gas flow comprising:

an inlet to receive an exhaust gas;

means to redirect the gas flow attached to said inlet so as to create a spiralling motion to said gas flow;

at least a first chamber attached to said means for redirecting said gas flow, said spiral gas flow passing along and about said at least first chamber;

a particulate collection means in or adjacent a perimeter wall of said at least first chamber and adjacent a distal end of said first chamber from said means to redirect said gas flow; and

an exhaust outlet at or adjacent a distal end of said first chamber from said means to redirect said gas flow and wherein said exhaust outlet is positioned to draw gas substantially centrally from said spiral gas flow through said chamber such that particulate matter may be centrifuged towards a perimeter wall and collected by said particulate collection means with exhaust gas of reduced particulates passing through exhaust outlet.

Further aspects of this invention will become apparent to those skilled in the art upon reading the following description.

### BRIEF DESCRIPTION OF THE DRAWINGS

This invention will now be described with reference to the following drawings in which:

FIG. 1 shows a cross-sectional side elevation through a first embodiment of the invention;

FIG. 2 shows a cross-sectional side elevation through a second embodiment of the invention;

FIG. 3 shows a front elevation of a portion of the embodiment of FIGS. 1 and 2;

FIG. 4 shows an end elevation of the embodiment of FIG. 1; and

FIG. 5 shows a cross-sectional side elevation through a portion of the apparatus of FIG. 1.

### DETAILED DESCRIPTION OF PREFERRED EMBODIMENTS

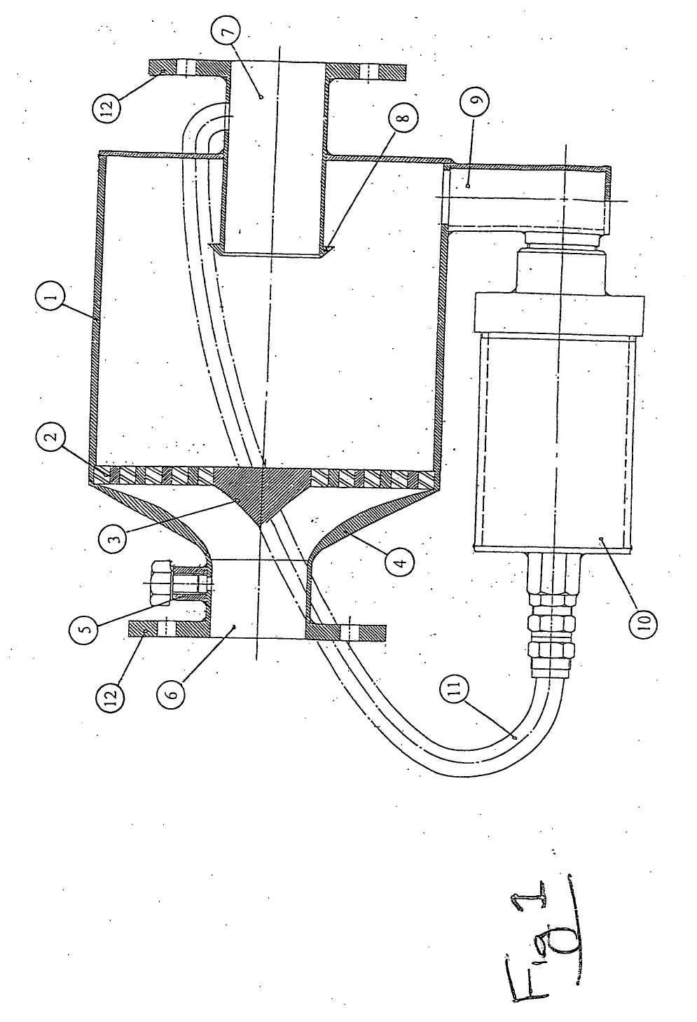

Referring to FIG. 1, a first embodiment of the apparatus is shown.

The apparatus of FIG. 1 includes an inlet 6 for the inlet of exhaust gases from a suitable gas or fluid stream such as the exhaust gas of a diesel or other such engine. The inlet 6 may comprise a suitable inlet for attachment into an existing or a modified exhaust system. Typically this may include some form of connection means 12 such as a flange having apertures for bolting to a cooperating flange in an exhaust system.

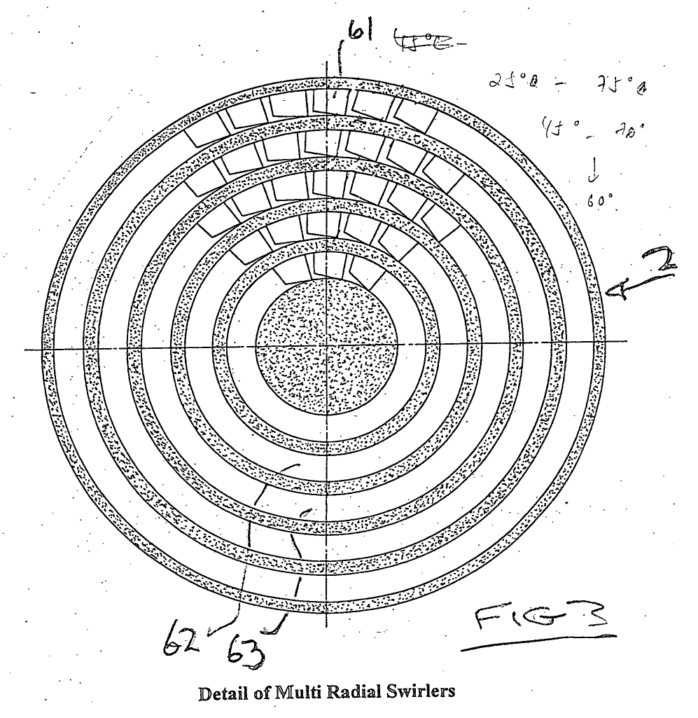

The exhaust flow may then pass through a means 2 intended to redirect the gas to create a spiral flow to the gas or fluid stream from the substantially linear fluid stream coming through the inlet 6. As shown in FIG. 3, this means may comprise a plurality of deflectors 61 at a suitable angle to deflect the linear flow and create a revolving gas flow around a chamber 1.

The chamber 1 is intended to contain the spiral flow and, as shown in this preferred embodiment, is a substantially cylindrical housing 1 such that the spiralling flow of fluid can pass around the interior of the outer walls of the chamber 1.

To improve the direction of the gas flow and its operation within the chamber 1, the deflector means 2 may be provided with a substantially solid conical centre 3 so as to help direct the flow towards the outer regions of the chamber 1.

Further, in this preferred embodiment, a diffuser 4 is provided intermediate of the inlet and the chamber 1 to reduce the velocity of the gas flow through the expansion to a larger diameter chamber 1 compared with the diameter of the inlet 6. The expansion to the chamber 1 may accommodate the gas flow further towards the outer regions of the chamber 1 as well as reducing velocity and reducing back pressure created by the deflection of the gas flow by the means 2.

At a distal end of the chamber 1, an exhaust outlet 7 may be provided. In this preferred form, the exhaust outlet 7 is provided substantially centrally to the longitudinal axis of the chamber 1 and does not progress to the outer edges of the chamber 1. Typically it would be sized approximately the same diameter as the inlet 6. It is also preferred that the entrance to the exhaust outlet 7 progresses into the chamber 1 so as to draw a stream of gas from closer to the centre of the chamber 1 both in terms of its longitudinal axis and further towards the centre from the distal end to which the outlet 7 is attached. It will be noted that the outlet 7 also has a connection flange 12 for a similar purpose to the inlet end being connection into an exhaust system.

The apparatus is intended to produce a swirling gas flow of reduced velocity around the chamber 1 that relies on both the reduction of velocity as well as a centrifugal effect of the swirled gas flow to collect particulate matter closer to the walls of the chamber 1 than to the central axis about which the outlet 7 is arranged. This particulate matter may collect within the chamber 1 and be drawn through an inlet port 9 into a reservoir 10 for collection of the particulate matter.

In this preferred embodiment, the port 9 and reservoir 10 are provided with some suction or gas flow through the port 9 and reservoir 10 so as to help draw in the particulate matter while seeking to minimize the effect on passage of a substantial quantity of gas flow out the exhaust outlet 7. It can be noted that a ventilation pipe 11 is connected to the particulate matter reservoir 10 and the exhaust outlet 7. With a stable quantity of gas flow through the inlet 6 and through the outlet 7, it will be appreciated that the velocities of the gas flow in the inlet 6 and outlet 7 need to be higher than in the chamber 1. The gas flow through the exhaust outlet 7 passing the end of the ventilation pipe 11 creates a vacuum effect in the ventilation pipe 11 that can be used to draw a secondary gas stream through the particulate matter inlet port 9 and the particulate matter reservoir 10.

In operation, the gas stream will enter the inlet port 6 and be redirected by the plates 61 in the means 2 as well as the conical centre 3 and create a slower swirling flow in the chamber 1. Particulate matter is centrifuged against the outer walls or falls from the gas stream due to the reduced velocity and may be collected adjacent an inlet port 9 at a distal lower end of the chamber 1. The exhaust outlet 7 is substantially centrally positioned within the chamber 1 to draw gas from a central region within the chamber which should be of lower density and carry less particulate matter from the centrifuging effect of the swirling gas flow.

Referring to FIG. 3, the means 2 may include a plurality of deflector plates 61 arranged in a plurality of concentric rings 62, 63, etc. Each deflector plate 61 may be at an angle to the direct linear gas flow from the inlet 6 to the outlet 7 and the angles may be varied between various deflector plates or indeed may be different from one ring 62 to the next ring 63 if desired. Typically the angle of the deflector plates may be in the range of 25 degrees to 75 degrees, more preferably 45 degrees to 70 degrees or even more preferably, approximately 60 degrees.

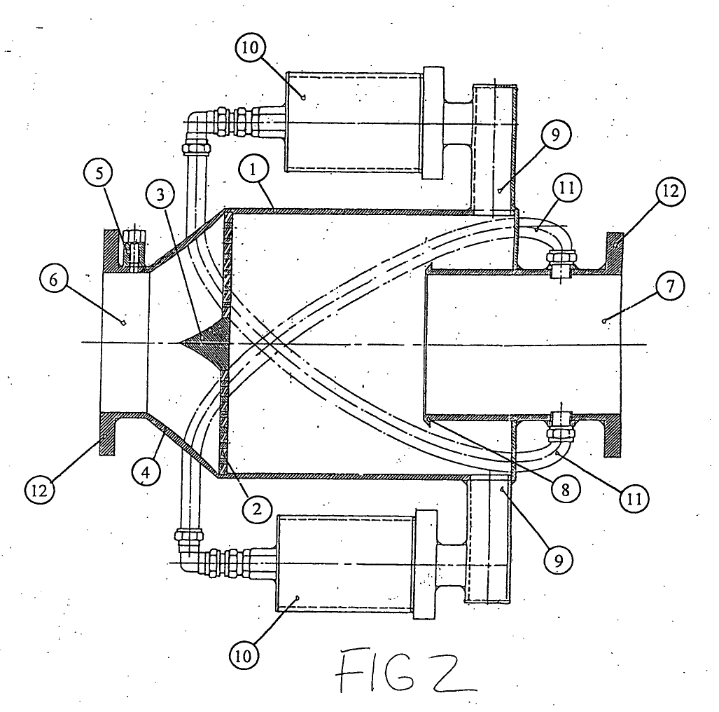

Referring to FIG. 2, a similar apparatus suitable for stationary engines is shown. This apparatus is similar to the apparatus as shown in FIG. 1 with again having an inlet 6, an outlet 7 and a larger diameter chamber 1 intermediate of the inlet and outlet. The deflector means 2 including its conical centre 3 are substantially the same as that provided in the previous embodiment although it will be noted that two particulate matter inlet ports and reservoirs are provided to collect particulate matter from both sides of the chamber 1 adjacent the end of the chamber 1 into which the exhaust outlet 7 is positioned. You will be noted that in these embodiments, the inlet port 9 for the particulate matter is preferably positioned behind the inlet end 8 of the exhaust outlet 7 such that the particulate matter would need to travel upstream against the gas stream to enter the exhaust outlet 7 and this provides further encouragement for the particulate matter to enter the inlet ports 9.

It can also be noted that a back pressure test point 5 is provided in the inlet so that suitable adjustments may be made if necessary to reduce back pressure on the engine or other device creating the exhaust flow. Such back pressure may be detrimental to the performance of the engine and a system that reduces this back pressure is preferred.

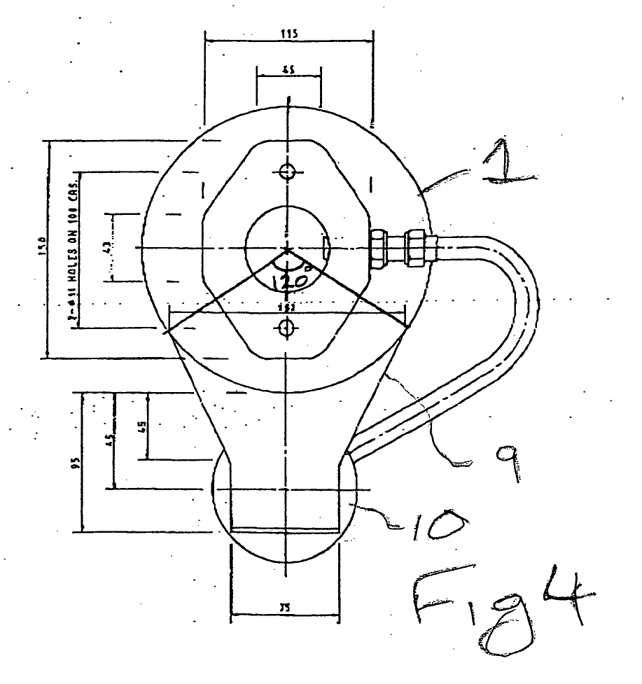

Referring to FIG. 4, an end elevation of the apparatus of FIG. 1 is shown. It can be noted that the inlet port for the particulate matter 9 may be in the form of a tapered or conical inlet port 9 opening over approximately 120 degrees of the circumference of the swirl chamber 1 and reducing diameter to a smaller diameter reservoir 10, Once particulate matter is collected within the inlet port 9, the reduction in diameter is unlikely to encourage any particulate matter to escape.

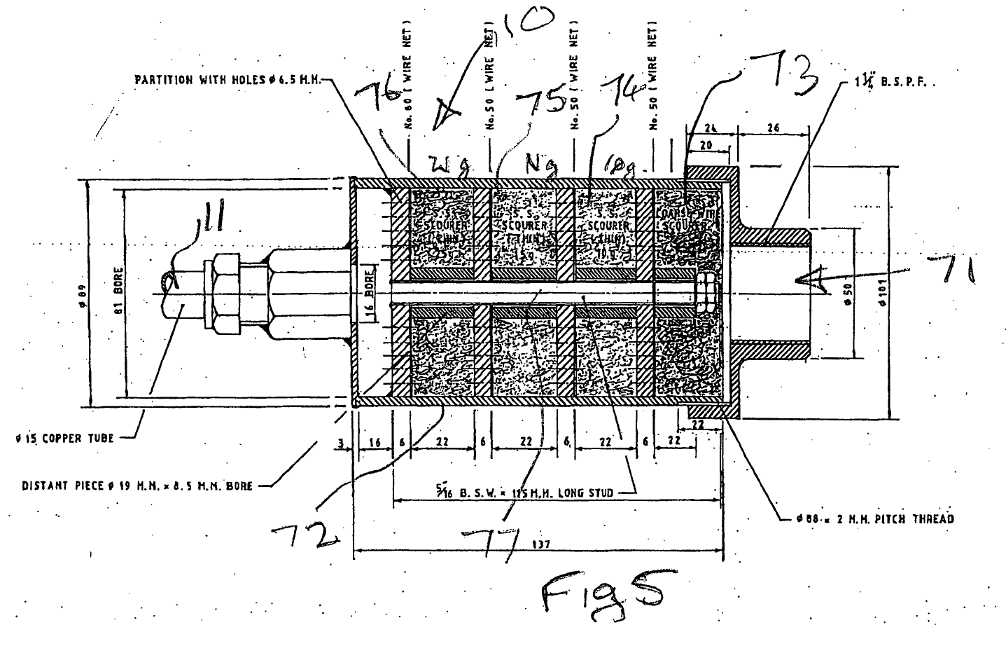

Referring to FIG. 5, a cross-sectional elevation is provided through the particulate matter reservoir 10. The particulate matter reservoir 10 may have an inlet 71 attached to the inlet port 9 and again be provided as a substantially cylindrical housing 72. Of course, any other shape of chamber may suffice as a swirling flow through this chamber is not necessary.

The chamber 10 may contain materials to assist in the collection and retention of particulate matter. Typically, a wire wool or other such collection material may act as a filter to the particulate matter heavy gas stream.

In this preferred form, a plurality of filtering regions is provided of varying densities to provide successive regions of greater filtration. A first region 73 may contain a coarse wire scourer to contain the largest of the particulate matters followed by successive regions 74, 75 and 76 having 10 μm., 15 μm. and 25 μm. of stainless steel scourer within. This effectively reduces the pour size of the scourer through each of the regions to provide the greater filtration. Each region may be separated by some form of wire net or similar partition or indeed simply abut each other if desired.

As shown in this preferred embodiment, a central stud 77 is provided to position, contain and compact the scourer into each partition.

Thus it can be seen that this invention provides an apparatus and a method of reducing particulate matters in exhaust gases with an intention of having a minimal effect on the back pressure of the engine and removing the largest quantities of particulate matters without providing direct inline filtration. Such direct inline filtration may significantly increase back pressures and may easily become clogged.

Although the filter or particulate matter reservoir 10 may require regular replacement or cleaning, the apparatus as provided may remove perhaps 35% of the particulate matter in a gas stream and if used in conjunction with a diesel automotive engine, could require removal and replacement after, for example, 10,000 km. Hence the burden of replacing the filter is not overly frequent and the filter itself is provided outside the main gas stream for greater accessibility and easier replacement.

Throughout this description, reference is made to specific integers which shall be deemed to incorporate known equivalents where appropriate. The description is provided by way of explanation and is not intended to be limiting to the scope of the invention as claimed.

1. A method of removing particulate materials and smoke from exhaust gases comprising:
passing the exhaust gas through means to create a spiral flow to the gas stream around a chamber;
collecting particulate matter at an end of said chamber distal from said means to create spiral flow of said gas; and
drawing exhaust gas from a substantially central portion of the spiral flow about said chamber at a distal end of said chamber from said means to create said spiral flow.

2. A method of removing particulate materials and smoke from exhaust gases as claimed in claim 1 wherein said method further includes reducing the velocity of the gas flow to create lower velocity flow through said chamber relative to the inlet velocity of the gas flow.

3. A method of removing particulate materials and smoke from exhaust gases as claimed in claim 1 wherein the method further includes collecting the particulate matter in a secondary chamber communicating with the chamber containing the spiral gas flow.

4. A method of removing particulate materials and smoke from exhaust gases as claimed in claim 3 wherein said method includes drawing said particulate matter into said secondary chamber with a secondary gas flow or vacuum.

5. A device for the removal of particulate matter from an exhaust gas flow comprising:
an inlet to receive an exhaust gas;
means to redirect the gas flow attached to said inlet so as to create a spiralling motion to said gas flow;
at least a first chamber attached to said means for redirecting said gas flow, said spiral gas flow passing along and about said at least first chamber;
a particulate collection means in or adjacent a perimeter wall of said at least first chamber and adjacent a distal end of said first chamber from said means to redirect said gas flow; and
an exhaust outlet at or adjacent a distal end of said first chamber from said means to redirect said gas flow and wherein said exhaust outlet is positioned to draw gas substantially centrally from said spiral gas flow through said chamber such that particulate matter may be centrifuged towards a perimeter wall and collected by said particulate collection means with exhaust gas of reduced particulates passing through exhaust outlet.

6. A device for the removal of particulate matter from an exhaust gas flow as claimed in claim 5 wherein said means to redirect the gas flow comprises a plurality of clad-like member having a face at an angle to the incoming gas flow.

7. A device for the removal of particulate matter from an exhaust gas flow as claimed in claim 6 wherein said clads are at an angle of between 25 and 75 degrees to the general direction of the incoming gas flow.

8. A device for the removal of particulate matter from an exhaust gas flow as claimed in claim 5 wherein said at least first chamber has substantially cylindrical interior walls.

9. A device for the removal of particulate matter from an exhaust gas flow wherein a diffuser is provided intermediate of said inlet and said first chamber and comprises an expansion of the diameter of the device from said inlet to said first chamber.

10. A device for the removal of particulate matter from an exhaust gas flow as claimed in claim 5 wherein said exhaust outlet has an inlet end positioned interior of the first chamber from said distal end to which said exhaust outlet is attached.

11. A device for the removal of particulate matter from an exhaust gas flow as claimed in claim 5 wherein said particulate collection means comprises a particulate inlet port and at least a second chamber for collecting of said particulate matter.

12. A device for the removal of particulate matter from an exhaust gas flow as claimed in claim 11 wherein said at least second chamber contains filtration means.

13. A device for the removal of particulate matter from an exhaust gas flow as claimed in claim 11 wherein said second chamber is provided with a ventilation pipe to allow a secondary gas flow through said particulate matter inlet port and said secondary chamber.

14. A device for the removal of particulate matter from an exhaust gas flow as claimed in claim 13 wherein said ventilation pipe is connected to said exhaust outlet of said first chamber.
